(19) United States
(12) Patent Application Publication
(10) Pub. No.: US 2012/0193488 A1
(43) Pub. Date: Aug. 2, 2012

(54) Computer Support Device Having An Angle Adjustable Function

(76) Inventors: Chen-Yu Chung, Taichung City (TW); Shih-Ming Lin, Dongguan City (TW)

(21) Appl. No.: 13/014,748

(22) Filed: Jan. 27, 2011

(51) Int. Cl. F16M 13/00

(52) U.S. Cl. 248/201

(57) ABSTRACT

A support device for a notebook computer includes an upright post, two connecting arms pivotally connected with each other, a lifting member mounted on the upright post and pivotally connected with a first one of the connecting arms, an adjusting member pivotally connected with a second one of the connecting arms, a connecting block pivotally connected with the adjusting member, and a support rack mounted on the connecting member. Thus, the connecting arms can be pivoted relative to each other and can be moved relative to the upright post to adjust the leftward and rightward angles of the support rack, while the support rack can be moved relative to the connecting arms to adjust the upward and downward angles of the support rack, so that the inclined angle of the support rack can be adjusted freely.

### BACKGROUND OF THE INVENTION

1. Field of the Invention

The present invention relates to a support device and, more particularly, to a support device for a computer, such as a notebook computer and the like.

2. Description of the Related Art

A notebook computer is portable and can be carried by a user easily and conveniently to facilitate the user operating the notebook computer in any place, such as the car, train and the like. The notebook computer can also be placed on a table or desk to function as a desktop computer. However, when the user needs to frequently adjust the angle between the screen and the keyboard so as to facilitate operation of the notebook computer, the pivot between the screen and the keyboard is easily worn out or broken due to a frequent rubbing action during a long-term utilization, thereby decreasing the lifetime of the notebook computer.

### BRIEF SUMMARY OF THE INVENTION

In accordance with the present invention, there is provided a support device, comprising an upright post, two connecting arms pivotally connected with each other, a lifting member adjustably mounted on the upright post and pivotally connected with a first one of the two connecting arms, an adjusting member pivotally connected with a second one of the two connecting arms, a connecting block pivotally connected with the adjusting member, and a support rack mounted on the connecting member. The lifting member is pivotally connected with the first one of the two connecting arms by a first pivot spindle, and the first one of the two connecting arms is releasably locked onto the first pivot spindle by a first adjusting knob and a first fixing washer. The first pivot spindle is locked onto the lifting member by a first locking screw. The two connecting arms are pivotally connected with each other by a second pivot spindle. The two connecting arms are releasably locked onto the second pivot spindle by a second adjusting knob and a second fixing washer. The second pivot spindle is locked onto the first one of the two connecting arms by a second locking screw. The adjusting member is pivotally connected with the second one of the two connecting arms by a third pivot spindle. The adjusting member is releasably locked onto the third pivot spindle by a third adjusting knob and a third fixing washer. The third pivot spindle is locked onto the second one of the two connecting arms by a third locking screw. The connecting member is pivotally connected with the adjusting member by a fourth pivot spindle. The fourth pivot spindle is releasably locked onto the adjusting member by a fourth adjusting knob and a fourth fixing washer. The connecting member is locked onto the fourth pivot spindle by a fourth locking screw. The support rack includes a fixed frame mounted on the connecting member, a movable frame pivotally connected with the fixed frame, and a sucker mounted on the fixed frame.

The primary objective of the present invention is to provide a computer support device having an angle adjustable function.

According to the primary advantage of the present invention, the two connecting arms can be pivoted relative to each other and can be moved relative to the upright post so as to adjust the leftward and rightward angles of the support rack, while the support rack can be moved relative to the two connecting arms so as to adjust the upward and downward angles of the support rack, so that the inclined angle of the support rack can be adjusted easily and freely in a three-dimensional manner.

According to another advantage of the present invention, the lifting member can be moved on the upright post upward and downward so as to adjust the height of the support rack so that the height and position of the support rack can be adjusted freely.

According to a further advantage of the present invention, the movable frame can be pivoted relative to the fixed frame so as to adjust the angle between the movable frame and the fixed frame so that the open angle of the support rack can be adjusted freely.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a support device in accordance with the preferred embodiment of the present invention.

FIG. 2 is an exploded perspective view of the support device as shown in FIG. 1.

FIG. 3 is a schematic operational view of the support device as shown in FIG. 1.

FIG. 4 is a schematic operational view of the support device as shown in FIG. 3.

FIG. 5 is a schematic operational view of the support device as shown in FIG. 4.

FIG. 6 is a schematic operational view of the support device as shown in FIG. 5.

FIG. 7 is a partially broken perspective view of the support device as shown in FIG. 1.

FIG. 8 is a schematic operational view of the support device as shown in FIG. 7.

FIG. 9 is a partially bottom perspective view of the support device as shown in FIG. 1.

FIG. 10 is a locally enlarged view of the support device as shown in FIG. 9.

FIG. 11 is a schematic operational view of the support device as shown in FIG. 10.

### DETAILED DESCRIPTION OF THE INVENTION

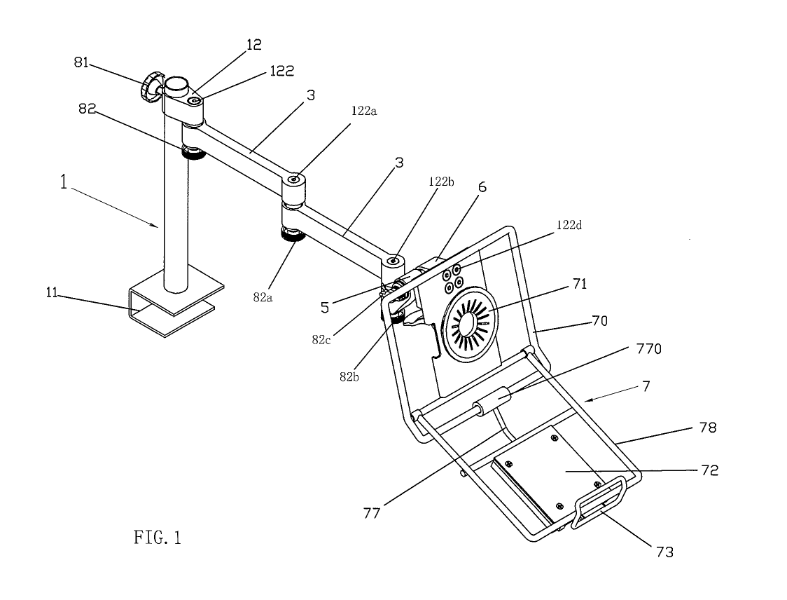

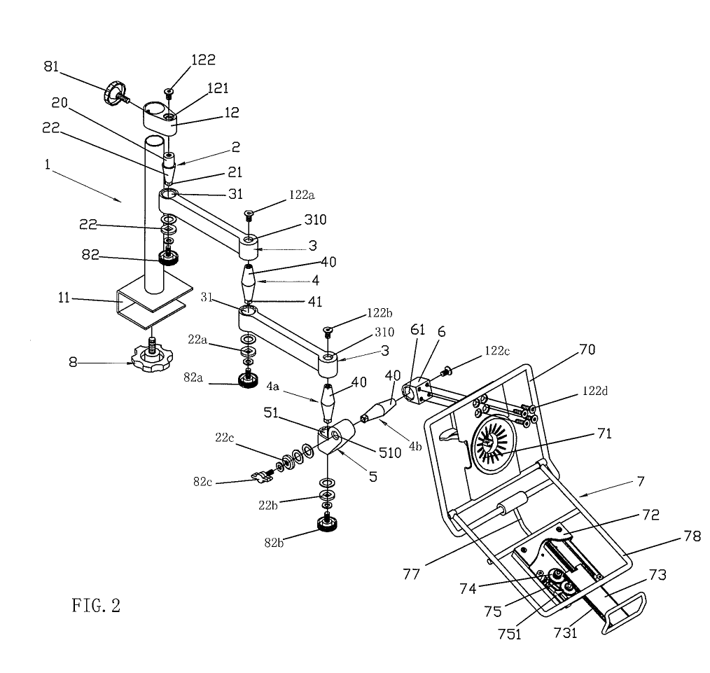

Referring to the drawings and initially to FIGS. 1 and 2, a support device for a notebook computer in accordance with the preferred embodiment of the present invention comprises an upright post 1, two connecting arms 3 pivotally connected with each other, a lifting member 12 adjustably mounted on the upright post 1 and pivotally connected with a first one of the two connecting arms 3, an adjusting member 5 pivotally connected with a second one of the two connecting arms 3, a connecting block 6 pivotally connected with the adjusting member 5, and a support rack 7 mounted on the connecting member 6.

The upright post 1 has a lower end provided with a clamping bracket 11, and a threaded fastening knob 8 is rotatably mounted on the clamping bracket 11 of the upright post 1 to lock the clamping bracket 11 of the upright post 1 onto an object, such as a table and the like.

The lifting member 12 is releasably locked onto the upright post 1 by a threaded locking knob 81. The lifting member 12 is pivotally connected with the first one of the two connecting arms 3 by a first pivot spindle 2, and the first one of the two connecting arms 3 is releasably locked onto the first pivot spindle 2 by a first adjusting knob 82 and a first fixing washer 22. The first pivot spindle 2 is locked onto the lifting member 12 by a first locking screw 122. The lifting member 12 has a first end mounted on the upright post 1 and a second end provided with a fixing hole 121 mounted on and connected with the first pivot spindle 2 by the first locking screw 122.

The two connecting arms 3 are pivotally connected with each other by a second pivot spindle 4. The two connecting arms 3 are releasably locked onto the second pivot spindle 4 by a second adjusting knob 82a and a second fixing washer 22a. The second pivot spindle 4 is locked onto the first one of the two connecting arms 3 by a second locking screw 122a. Each of the two connecting arms 3 has a first end provided with a first mounting hole 31 and a second end provided with a second mounting hole 310. The first mounting hole 31 of the first one of the two connecting arms 3 is mounted on and connected with the first pivot spindle 2 by the first adjusting knob 82 and the first fixing washer 22. The second mounting hole 310 of the first one of the two connecting arms 3 is mounted on and connected with the second pivot spindle 4 by the second locking screw 122a. The first mounting hole 31 of the second one of the two connecting arms 3 is mounted on and connected with the second pivot spindle 4 by the second adjusting knob 82a and the second fixing washer 22a.

The adjusting member 5 is pivotally connected with the second one of the two connecting arms 3 by a third pivot spindle 4a. The adjusting member 5 is releasably locked onto the third pivot spindle 4a by a third adjusting knob 82b and a third fixing washer 22b. The third pivot spindle 4a is locked onto the second one of the two connecting arms 3 by a third locking screw 122b, and the second mounting hole 310 of the second one of the two connecting arms 3 is mounted on and connected with the third pivot spindle 4a by the third locking screw 122b. The adjusting member 5 has a first end provided with a first mounting bore 51 and a second end provided with a second mounting bore 510. The first mounting bore 51 of the adjusting member 5 is mounted on and connected with the third pivot spindle 4a by the third adjusting knob 82b and the third fixing washer 22b. The second mounting bore 510 of the adjusting member 5 is perpendicular to the first mounting bore 51.

The connecting member 6 is pivotally connected with the adjusting member 5 by a fourth pivot spindle 4b. The fourth pivot spindle 4b is releasably locked onto the adjusting member 5 by a fourth adjusting knob 82c and a fourth fixing washer 22c, and the second mounting bore 510 of the adjusting member 5 is mounted on and connected with the fourth pivot spindle 4b by the fourth adjusting knob 82c and the fourth fixing washer 22c. The connecting member 6 is locked onto the fourth pivot spindle 4b by a fourth locking screw 122c and has an inner portion provided with a fixing bore 61 mounted on and connected with the fourth pivot spindle 4b by the fourth locking screw 122c.

The first pivot spindle 2 has an upper end provided with a rod 20 inserted into the fixing hole 121 of the lifting member 12 and connected with the first locking screw 122. The first pivot spindle 2 has a lower end provided with a tapered portion 22 inserted into the first mounting hole 31 of the first one of the two connecting arms 3. The tapered portion 22 of the first pivot spindle 2 has a bottom provided with a square fixing piece 21 fixed in the first fixing washer 22.

The second pivot spindle 4, the third pivot spindle 4a and the fourth pivot spindle 4b have the same shape and structure. Each of the second pivot spindle 4, the third pivot spindle 4a and the fourth pivot spindle 4b has a first end and a second end each provided with a tapered section 40. Each of the second pivot spindle 4, the third pivot spindle 4a and the fourth pivot spindle 4b has an end face provided with a square fixing stud 41 fixed in the second fixing washer 22a, the third fixing washer 22b and the fourth fixing washer 22c.

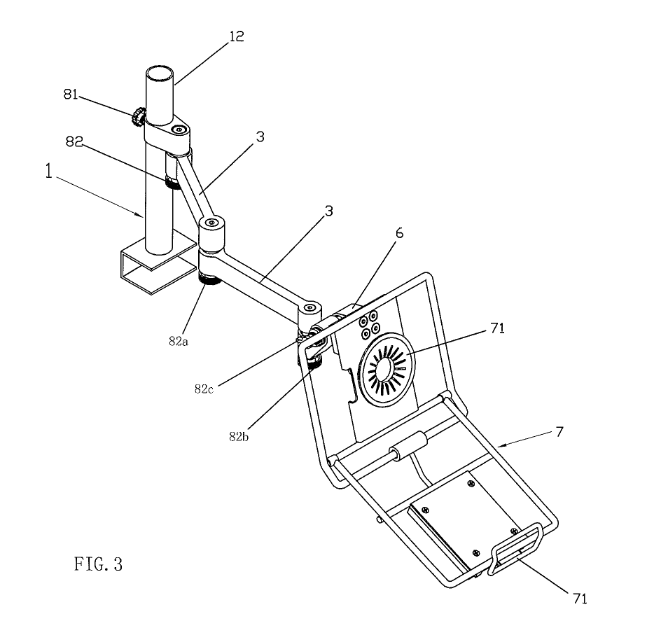

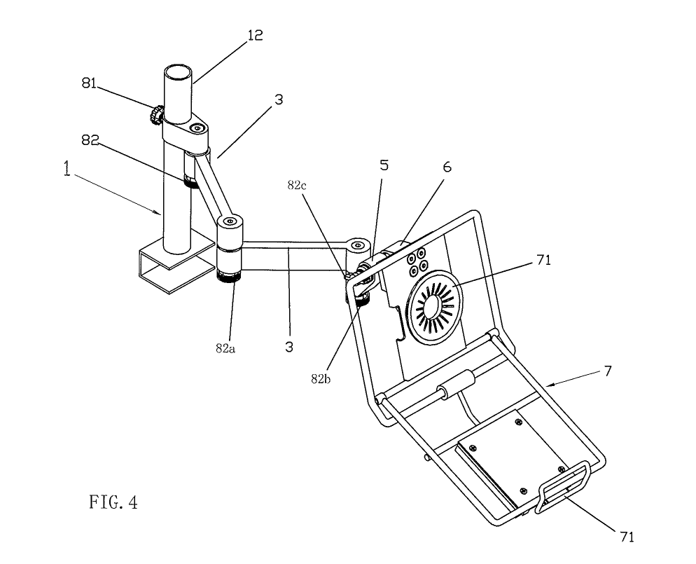

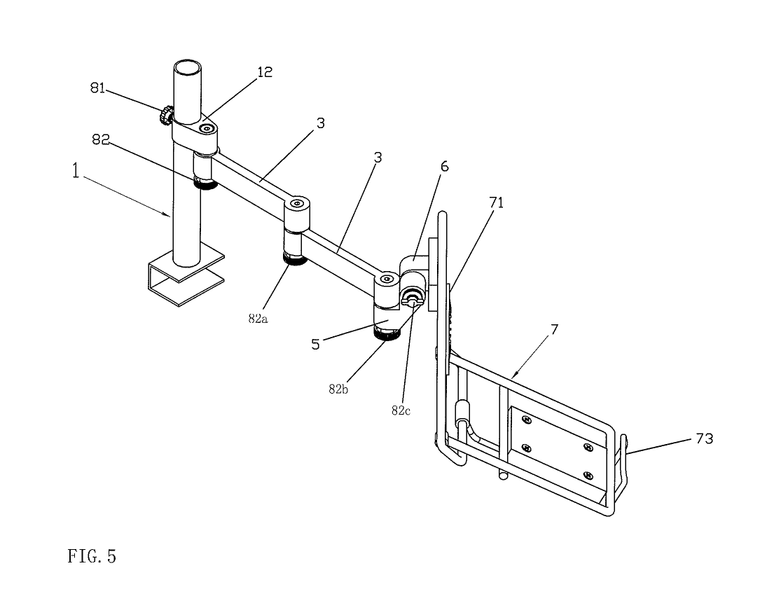

In operation, referring to FIGS. 3-6 with reference to FIGS. 1 and 2, the lifting member 12 can be moved on the upright post 1 upward and downward by releasing the threaded locking knob 81 as shown in FIG. 3 so as to adjust the height of the support rack 7. Alternatively, the two connecting arms 3 can be pivoted relative to each other and moved relative to the upright post 1 by releasing the first adjusting knob 82, the second adjusting knob 82a and the third adjusting knob 82b so as to adjust the leftward and rightward angles of the support rack 7 as shown in FIGS. 3-5. Alternatively, the support rack 7 can be moved relative to the two connecting arms 3 by releasing the fourth adjusting knob 82c so as to adjust the upward and downward angles of the support rack 7 as shown in FIG. 6.

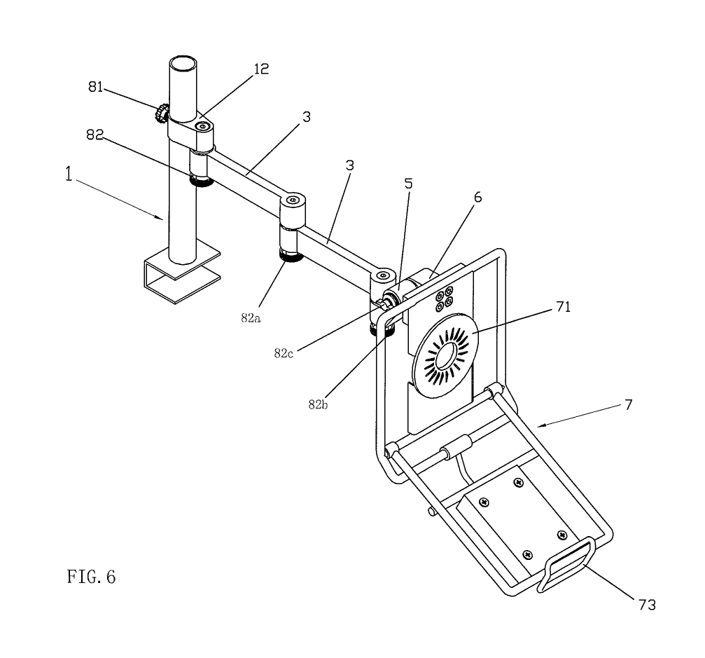

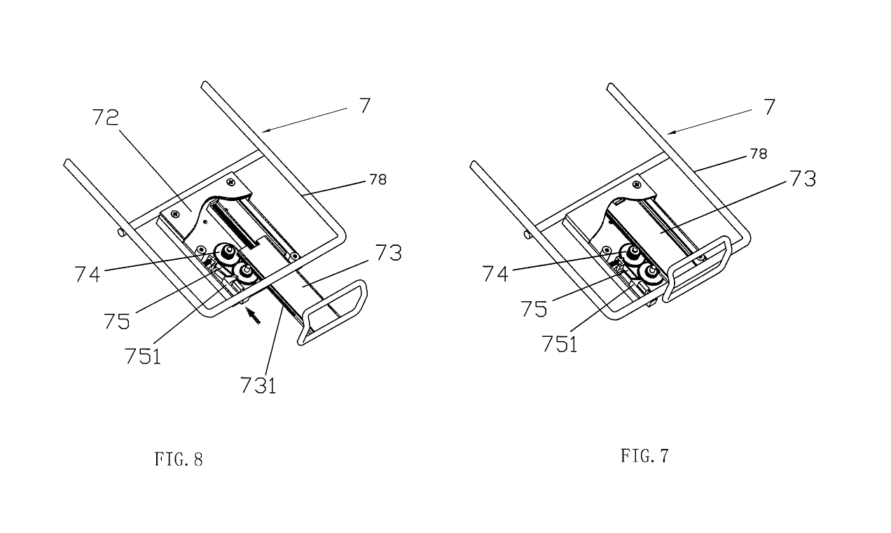

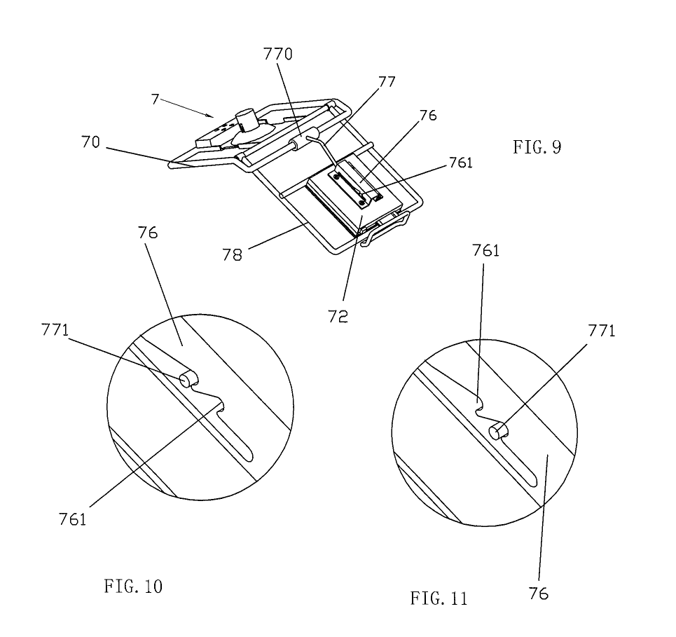

Referring to FIGS. 7-11 with reference to FIGS. 1 and 2, the support rack 7 is locked onto the connecting member 6 by a plurality of set screws 122d. The support rack 7 includes a fixed frame 70 mounted on the connecting member 6, a movable frame 78 pivotally connected with the fixed frame 70, and a sucker 71 mounted on the fixed frame 70 to attract a computer, such as a notebook computer and the like. The support rack 7 further includes a housing 72 mounted on the movable frame 78, a pull bracket 73 movably mounted on the housing 72 and having a side provided with an elongated toothed portion 731, at least one gear 74 rotatably mounted in the housing 72 and meshing with the toothed portion 731 of the pull bracket 73, a spring-biased locking plate 75 pivotally mounted in the housing 72 and detachably locked onto the gear 74 to releasably lock the gear 74 and the toothed portion 731 of the pull bracket 73, and a release button 751 movably mounted in the housing 72 and movable to press the locking plate 75 to detach the locking plate 75 from the gear 74 so as to release the gear 74 and to unlock the toothed portion 731 of the pull bracket 73. The support rack 7 further includes a locking bracket 76 mounted on the housing 72 and having a plurality of locking grooves 761, and an adjusting bar 77 pivotally connected between the fixed frame 70 and the movable frame 78 and having a first end provided with a connecting sleeve 770 pivotally mounted on the fixed frame 70 and a second end provided with a locking rod 771 detachably locked in one of the locking grooves 761 of the locking bracket 76.

In operation, when the release button 751 is moved to press the locking plate 75, the locking plate 75 is pivoted to detach from the gear 74 so as to release the gear 74 and to unlock the toothed portion 731 of the pull bracket 73 so that the pull bracket 73 can be moved relative to the movable frame 78 as shown in FIGS. 7 and 8 so as to adjust the distance between the pull bracket 73 and the movable frame 78. In addition, the rod 771 of the adjusting bar 77 is moved relative to the locking bracket 76 and can be locked in any one of the locking grooves 761 of the locking bracket 76 as shown in FIGS. 10 and 11 so that the adjusting bar 77 can be pivoted between the fixed frame 70 and the movable frame 78 so as to adjust the angle between the fixed frame 70 and the movable frame 78.

Accordingly, the two connecting arms 3 can be pivoted relative to each other and can be moved relative to the upright post 1 so as to adjust the leftward and rightward angles of the support rack 7, while the support rack 7 can be moved relative to the two connecting arms 3 so as to adjust the upward and downward angles of the support rack 7, so that the inclined angle of the support rack 7 can be adjusted easily and freely in a three-dimensional manner. In addition, the lifting member 12 can be moved on the upright post 1 upward and downward so as to adjust the height of the support rack 7 so that the height and position of the support rack 7 can be adjusted freely. Further, the movable frame 78 can be pivoted relative to the fixed frame 70 so as to adjust the angle between the movable frame 78 and the fixed frame 70 so that the open angle of the support rack 7 can be adjusted freely.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A support device, comprising:
an upright post;
two connecting arms pivotally connected with each other;
a lifting member adjustably mounted on the upright post and pivotally connected with a first one of the two connecting arms;
an adjusting member pivotally connected with a second one of the two connecting arms;
a connecting block pivotally connected with the adjusting member; and
a support rack mounted on the connecting member.

2. The support device of claim 1, wherein
the lifting member is pivotally connected with the first one of the two connecting arms by a first pivot spindle;
the first one of the two connecting arms is releasably locked onto the first pivot spindle by a first adjusting knob and a first fixing washer;
the first pivot spindle is locked onto the lifting member by a first locking screw;
the two connecting arms are pivotally connected with each other by a second pivot spindle;
the two connecting arms are releasably locked onto the second pivot spindle by a second adjusting knob and a second fixing washer;
the second pivot spindle is locked onto the first one of the two connecting arms by a second locking screw;
the adjusting member is pivotally connected with the second one of the two connecting arms by a third pivot spindle;
the adjusting member is releasably locked onto the third pivot spindle by a third adjusting knob and a third fixing washer;
the third pivot spindle is locked onto the second one of the two connecting arms by a third locking screw;
the connecting member is pivotally connected with the adjusting member by a fourth pivot spindle;
the fourth pivot spindle is releasably locked onto the adjusting member by a fourth adjusting knob and a fourth fixing washer;
the connecting member is locked onto the fourth pivot spindle by a fourth locking screw.

3. The support device of claim 2, wherein
each of the two connecting arms has a first end provided with a first mounting hole and a second end provided with a second mounting hole;
the first mounting hole of the first one of the two connecting arms is mounted on and connected with the first pivot spindle by the first adjusting knob and the first fixing washer;
the second mounting hole of the first one of the two connecting arms is mounted on and connected with the second pivot spindle by the second locking screw;
the first mounting hole of the second one of the two connecting arms is mounted on and connected with the second pivot spindle by the second adjusting knob and the second fixing washer;
the second mounting hole of the second one of the two connecting arms is mounted on and connected with the third pivot spindle by the third locking screw.

4. The support device of claim 3, wherein the lifting member has a first end mounted on the upright post and a second end provided with a fixing hole mounted on and connected with the first pivot spindle by the first locking screw.

5. The support device of claim 2, wherein
the adjusting member has a first end provided with a first mounting bore and a second end provided with a second mounting bore;
the first mounting bore of the adjusting member is mounted on and connected with the third pivot spindle by the third adjusting knob and the third fixing washer;
the second mounting bore of the adjusting member is mounted on and connected with the fourth pivot spindle by the fourth adjusting knob and the fourth fixing washer.

6. The support device of claim 2, wherein the connecting member has an inner portion provided with a fixing bore mounted on and connected with the fourth pivot spindle by the fourth locking screw.

7. The support device of claim 3, wherein the second mounting bore of the adjusting member is perpendicular to the first mounting bore.

8. The support device of claim 4, wherein
the first pivot spindle has an upper end provided with a rod inserted into the fixing hole of the lifting member and connected with the first locking screw;
the first pivot spindle has a lower end provided with a tapered portion inserted into the first mounting hole of the first one of the two connecting arms;
the tapered portion of the first pivot spindle has a bottom provided with a square fixing piece fixed in the first fixing washer.

9. The support device of claim 2, wherein
each of the second pivot spindle, the third pivot spindle and the fourth pivot spindle has a first end and a second end each provided with a tapered section;
each of the second pivot spindle, the third pivot spindle and the fourth pivot spindle has an end face provided with a square fixing stud fixed in the second fixing washer, the third fixing washer and the fourth fixing washer.

10. The support device of claim 1, wherein the support rack includes:
a fixed frame mounted on the connecting member;
a movable frame pivotally connected with the fixed frame; and
a sucker mounted on the fixed frame.

11. The support device of claim 10, wherein the support rack further includes:
a housing mounted on the movable frame;
a pull bracket movably mounted on the housing and having a side provided with an elongated toothed portion;
at least one gear rotatably mounted in the housing and meshing with the toothed portion of the pull bracket;
a spring-biased locking plate pivotally mounted in the housing and detachably locked onto the gear to releasably lock the gear and the toothed portion of the pull bracket; and
a release button movably mounted in the housing and movable to press the locking plate to detach the locking plate from the gear so as to release the gear and to unlock the toothed portion of the pull bracket.

12. The support device of claim 11, wherein the support rack further includes:
a locking bracket mounted on the housing and having a plurality of locking grooves; and
an adjusting bar pivotally connected between the fixed frame and the movable frame and having a first end provided with a connecting sleeve pivotally mounted on the fixed frame and a second end provided with a locking rod detachably locked in one of the locking grooves of the locking bracket.

13. The support device of claim 10, wherein the support rack is locked onto the connecting member by a plurality of set screws.

14. The support device of claim 4, wherein the lifting member is releasably locked onto the upright post by a threaded locking knob.
